(19) United States
(12) Patent Application Publication
(10) Pub. No.: US 2026/0299327 A1
(43) Pub. Date: Oct. 1, 2026

(54) MULTIDIRECTIONAL PN-JUNCTION MODULATOR

(71) Applicant: Ciena Corporation, Hanover, MD (US)

(72) Inventors: Christopher Daunt, Vasteras (SE); John Puthenparampil George, Brussels (BE); Lukas Elsinger, Jersey City, NJ (US)

(21) Appl. No.: 19/577,898

(22) Filed: Mar. 25, 2026

Related U.S. Application Data
(60) Provisional application No. 63/778,833, filed on Mar. 27, 2025.

(51) Int. Cl. G02F 1/025

(52) U.S. Cl. CPC G02F 1/025

(57) ABSTRACT

An example optical modulator includes a ridge waveguide core disposed along a substrate. The ridge waveguide core is made of a semiconductor material that includes: a first n-doped region and a first p-doped region arranged to form a first p-n junction along a longitudinal direction of the ridge waveguide core; a second n-doped region formed by counter-doping a portion of the first p-doped region; and a second p-doped region formed by counter-doping a portion of the first n-doped region. The second n-doped region and the first p-doped region are arranged to form a second p-n junction along the longitudinal direction. The second p-doped region and the first n-doped region are arranged to form a third p-n junction along the longitudinal direction.

### CROSS-REFERENCE TO RELATED APPLICATIONS

This application claims the benefit of U.S. Provisional Patent Application No. 63/778,833, filed 27 Mar. 2025, and entitled “T-JUNCTION LATERAL PN MODULATOR,” the contents of which are incorporated herein by reference.

### FIELD OF THE DISCLOSURE

Various example embodiments relate to optical communication equipment and, more specifically but not exclusively, to optical modulators.

### BACKGROUND

An optical modulator is a device that alters one or more characteristics of an optical beam, such as its amplitude, phase, and/or polarization, in response to an electrical drive signal. Some electrical drive signals can be used to encode data onto the optical beam for communication or other applications. The modulated optical beam may be carried over free space or propagated through an optical waveguide (e.g., an optical fiber). In some use cases, modulators may be categorized into amplitude modulators, phase modulators, polarization modulators, etc.

### BRIEF SUMMARY OF SOME SPECIFIC EMBODIMENTS

Example embodiments provide various multidirectional p-n junction structures for incorporation into a ridge waveguide core of an integrated optical modulator. Such structures may beneficially be used to enable a reduction in one or more of the drive voltage, insertion loss, and device capacitance of the modulator. At least some embodiments may be used to improve bandwidth performance and modulation efficiency, thereby making the corresponding integrated optical modulator more suitable for optical communication networks designed for high-speed data transmission and efficient signal processing.

In one example, an apparatus comprises: a substrate; and a ridge waveguide core disposed along the substrate and comprising a semiconductor material that includes: a first n-doped region and a first p-doped region arranged to form a first p-n junction along a longitudinal direction of the ridge waveguide core; a second n-doped region formed by counter-doping a portion of the first p-doped region; and a second p-doped region formed by counter-doping a portion of the first n-doped region, wherein the second n-doped region and the first p-doped region are arranged to form a second p-n junction along the longitudinal direction; and wherein the second p-doped region and the first n-doped region are arranged to form a third p-n junction along the longitudinal direction.

In another example, a fabrication method comprises: forming a ridge waveguide core on a substrate, the ridge waveguide core comprising a semiconductor material; n-doping the semiconductor material to create a first n-doped region in the ridge waveguide core; p-doping the semiconductor material to create a first p-doped region in the ridge waveguide core; counter-doping a portion of the first p-doped region to create a second n-doped region in the ridge waveguide core; counter-doping a portion of the first n-doped region to create a second p-doped region in the ridge waveguide core, wherein the first n-doped region and the first p-doped region arranged to form a first p-n junction along a longitudinal direction of the ridge waveguide core; wherein the second n-doped region and the first p-doped region are arranged to form a second p-n junction along the longitudinal direction; and wherein the second p-doped region and the first n-doped region are arranged to form a third p-n junction along the longitudinal direction.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 is a block diagram illustrating an optical transmitter according to some examples.

FIG. 2 is a schematic diagram illustrating a cross-sectional view of a phase shifter that can be used in the optical transmitter of FIG. 1 according to some examples.

FIGS. 3A-3B schematically illustrate structural and electrical characteristics of a ridge waveguide core used in the phase shifter of FIG. 2 according to some examples.

FIGS. 4A-4B schematically illustrate structural and electrical characteristics of a ridge waveguide core used in the optical phase shifter of FIG. 2 according to some additional examples.

FIGS. 5A-5E schematically illustrate a method of fabricating the ridge waveguide core of FIG. 4A according to some examples.

FIGS. 6A-6B schematically illustrate structural and electrical characteristics of a ridge waveguide core used in the optical phase shifter of FIG. 2 according to some further examples.

FIG. 7 is a schematic diagram illustrating a 3D perspective view of a longitudinal section of the ridge waveguide core of FIG. 4A according to some examples.

FIG. 8 is a schematic diagram illustrating a 3D perspective view of a longitudinal section of the ridge waveguide core of FIG. 4A according to some additional examples.

FIG. 9 is a schematic diagram illustrating a small signal equivalent circuit representation of the longitudinal section of FIG. 8 according to some examples.

FIGS. 10A-10C graphically compare selected performance characteristics of several ridge waveguide cores that can be used in the optical transmitter of FIG. 1 according to some examples.

### DETAILED DESCRIPTION

In at least some opto-electronic communication systems, a photonic integrated circuit (PIC)-based transmitter plays an important role in converting and modulating an electrical (e.g., data) input signal onto an optical carrier for transmission. This process is facilitated by an integrated photonic waveguide, which serves as the medium for propagating optical signals. The electrical signal, carrying encoded data, is introduced into an optical modulator by an electrical driver. The optical modulator encodes the electrical signal onto the optical carrier by altering its characteristics, such as phase and/or amplitude, through a process of modulation. A resulting output is a modulated optical signal that can be efficiently transmitted over an optical medium, such as an optical fiber, e.g., for high-speed communication.

In a conventional CMOS-based Silicon on Insulator (SOI) PIC platform, the lack of inversion symmetry in silicon crystals means that intrinsic electro-optic effects are substantially absent. Consequently, electrical-to-optical signal conversion typically relies on p-n junctions, leveraging the electrical properties of semiconductor diodes. When an electrical potential is applied between the cathode and anode of a semiconductor diode, the refractive index of the material is altered through carrier injection or depletion modulation, thereby enabling control over the phase and/or amplitude of the optical signal passing through the material. A lateral p-n junction modulator leverages this principle to achieve high-speed, efficient modulation of the optical carrier in response to an electrical input.

Some example embodiments are directed to a T-junction p-n depletion modulator fabricated using the SOI material platform. At least some embodiments offer improvements including, but not limited to, better modulation efficiency, reduced optical losses, and/or extended bandwidth compared to some existing solutions.

Some embodiments disclosed herein provide an optimized p-n junction structure that enables a reduction in the drive voltage, insertion loss, and/or device capacitance. Such embodiments can be used to improve bandwidth performance and efficiency, thereby making the lateral p-n junction modulator more suitable for optical communication networks designed for high-speed data transmission and efficient signal processing.

FIG. 1 is a block diagram illustrating an optical transmitter 100 according to some examples. The optical transmitter 100 includes a laser 102, an electrical driver 110, and an optical modulator 120. The laser 102 operates to generate an optical beam 104 which is applied to an optical input port of the optical modulator 120. In some examples, the optical beam 104 is a continuous wave (CW) beam. In the example shown, the electrical driver 110 operates to generate one or more electrical drive signals 112 for driving the optical modulator 120 in response to an input data stream 108. In response to the electrical drive signal(s) 112, the optical modulator 120 modulates the optical beam 104, thereby generating a modulated optical signal 122 having encoded therein the input data stream 108.

In some examples, the optical modulator 120 comprises or is a Mach-Zehnder Modulator (MZM). An MZM operates based on the principles of interference, leveraging the Mach-Zehnder interferometer structure to manipulate the phase and intensity of transmitted light. In a representative example, an MZM has two waveguide arms that split from a common input waveguide and recombine at a common output waveguide. The modulation process begins with an input light signal being divided into two arms by a beam splitter. Each arm (or path) contains a respective phase shifter, such as a p-n or PIN junction, which modulates the phase of the light passing through in response to an applied electrical modulation signal. When the light beams from the two arms are recombined at the output, the interaction between the modulated light waves results in constructive or destructive interference, thereby modulating the intensity of the output light signal, e.g., the modulated optical signal 122.

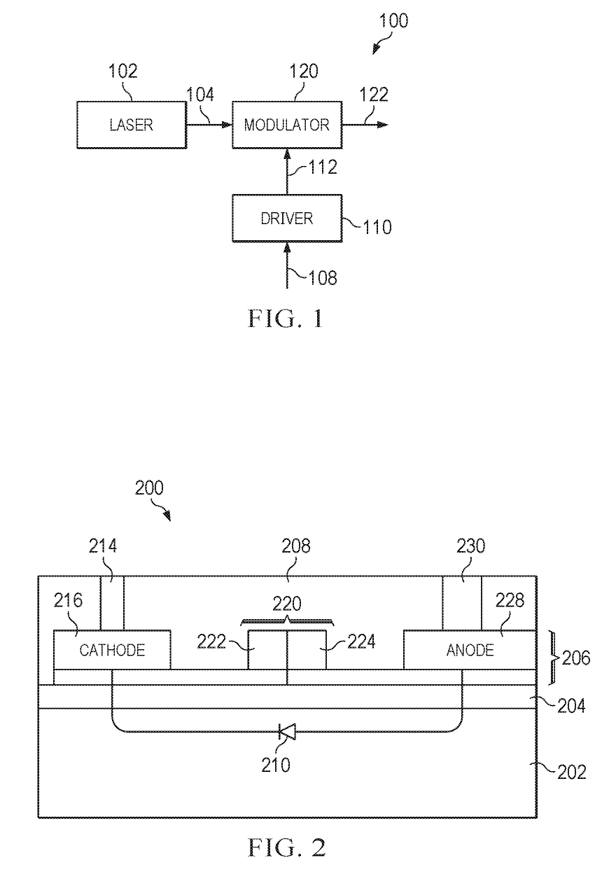

FIG. 2 is a schematic diagram illustrating a cross-sectional view of an optical phase shifter 200 that can be used in the optical modulator 120 according to some examples. More specifically, a respective instance of the phase shifter 200 may be used in each arm of an MZM. In the example shown, the phase shifter 200 is implemented using a SOI wafer and includes a handle layer (substrate) 202, a buried oxide (BOX) layer 204, and a device layer 206. The substrate 202 is a relatively thick (typically silicon) layer that provides mechanical support. The BOX layer 204 is an insulating layer, typically silicon dioxide (SiO₂), that electrically isolates the device layer 206 from the substrate 202. The device layer 206 is a relatively thin, high‑quality single‑crystal silicon layer where pertinent device structures are formed.

The phase shifter 200 includes a ridge waveguide core 220 formed in the device layer 206. The core 220 has an n-doped region 222 and a p-doped region 224, which form a lateral p-n junction. The p-n junction 222/224 can be electrically biased using a first electrode 216 (acting as a cathode) and a second electrode 228 (acting as an anode) and electrically presents itself as a diode 210. The first and second electrodes 216 and 228 can be electrically connected to an external voltage/current source (such as the electrical driver 110, FIG. 1) via electrical contacts 214 and 230, respectively. An interlayer dielectric 208 provides electrical insulation between the electrodes and different traces of the metal interconnect. In addition, portions of the interlayer dielectric 208 adjacent to the ridge waveguide core 220 serve as a cladding of the corresponding optical waveguide.

When a voltage is applied between the cathode 216 and the anode 228, the effective refractive index of the semiconductor material of the ridge waveguide core 220 is altered through carrier injection or depletion modulation, thereby enabling control over the phase of light passing through the optical waveguide. In the example shown, the p-n junction 222/224 has a depletion region near the center of the ridge waveguide core 220 or, in some cases, slightly off-center. When the diode 210 is reverse-biased, it sweeps carriers out of the junction, causing the depletion region to widen. As the depletion region increasingly overlaps with the optical mode, it enhances the refractive index modulation and reduces optical losses, by reducing the free carrier absorption.

In some examples, the first and second electrodes 216 and 228 are implemented as traveling-wave (TW) electrodes connected to receive the respective electrical drive signals 112. In some examples, each of the TW electrodes 216 and 228 is implemented as a transmission line (T-line), e.g., a coplanar waveguide (CPW), which runs from the corresponding electrical input port to a matched impedance resistor. This design may present several benefits. For example, by integrating the electrode’s capacitive loading into the T-line, the effective electrical bandwidth may be broadened. With the capacitance not substantially limiting the bandwidth, it becomes possible to implement a longer phase shifter, e.g., several millimeters in length, capable of achieving a larger optical extinction ratio (ER). In addition, a matched-impedance transmission line and termination can absorb potential reflections in the high-speed signal path. Furthermore, the electrical (microwave) and optical (light) propagation velocities can be matched in a relatively straightforward manner without significant changes to the overall circuit design.

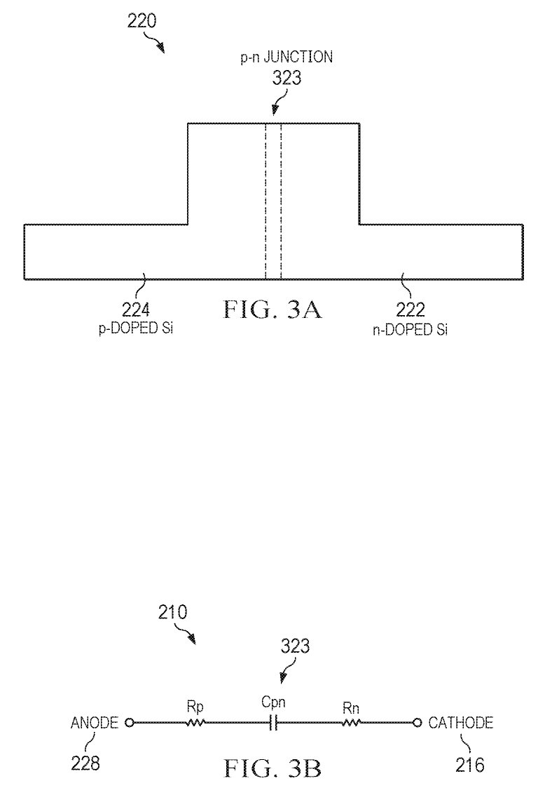

The following considerations can be taken into account when constructing a circuit model of a structure including a p-n junction operated under various conditions. These considerations are applied to the circuit models described below in reference to FIGS. 3B, 4B, 6B, and 9.

A p-n junction can be modeled as a diode when carrier transport across the junction is dominated by rectifying behavior, i.e., direction dependent current flow governed by the junction’s built in potential and applied bias, rather than by charge storage or capacitive effects. A particular p-n junction may be modeled as a diode when: (i) forward bias is applied, wherein the p side is biased positive with respect to the n side; (ii) the applied voltage reduces the built-in potential of the junction; (iii) majority carriers are injected across the junction; and (iv) current increases substantially exponentially with the applied voltage.

A p-n junction can be modeled as a capacitor when its charge storage varies with applied voltage so that a small change in voltage produces a proportional change in the stored charge. This behavior occurs under certain specific bias and signal conditions, leading to two distinct capacitance models. More specifically, a p-n junction may exhibit a capacitance attributable either to a depletion region formed under reverse bias or to a stored mobile charge under forward bias.

The depletion capacitance model typically applies when: (i) the p-n junction is reverse biased; (ii) the depletion region is substantially free of mobile carriers; and (iii) signals are relatively small signal and quasistatic (e.g., frequency is low enough such that the depletion region can respond to the waveform). Under these conditions, the p side and n side act as plates of the capacitor. The depletion region acts as an inter-plate dielectric. Increasing the reverse bias widens the depletion region, thereby reducing the capacitance.

The diffusion capacitance model typically applies when: (i) the p-n junction is forward biased; (ii) significant stored charge exists in the neutral regions; and (iii) signal frequency is low to moderate, thereby allowing carrier recombination dynamics to follow the waveform. Under these conditions, capacitance arises from stored minority carriers, not the depletion region. The capacitance value is substantially proportional to how much excess charge is stored per unit voltage. Unlike depletion capacitance, diffusion capacitance: (i) does not arise from an insulating depletion region; (ii) arises from stored charge associated with current conduction; and (iii) exists only when the junction conducts current.

At high frequencies, under large signal transients, or during non-quasistatic operation, the above capacitor models may break down, and time-dependent transport models may need to be used instead.

FIGS. 3A-3B schematically illustrate structural and electrical characteristics of the ridge waveguide core 220 according to some examples. More specifically, FIGS. 3A is a more detailed cross-sectional side view of the ridge waveguide core 220 illustrated in FIG. 2. FIG. 3B is a schematic diagram illustrating a small signal equivalent circuit representation of the corresponding diode 210 (also see FIG. 2).

In the example shown in FIG. 3A, the cathode side 222 of the core 220 comprises n-doped silicon. The anode side 224 of the core 220 similarly comprises p-doped silicon. The p-n junction region between the two lateral sides of the core 220 is labeled using the reference numeral 323.

As illustrated in FIG. 3B, the equivalent electrical circuit of the diode 210 is an RC circuit connected between the anode electrode 228 and the cathode electrode 216. Therein, the resistors Rₚ and Rₙ represent the resistance of the anode side 224 and the cathode side 222, respectively (also see FIG. 3A). The capacitor Cₚₙ represents the capacitance of the p-n junction region 323.

In at least some applications, the optical-modulation performance of the ridge waveguide core 220 illustrated in FIGS. 3A-3B may be constrained by inherent limitations, such as the RC time constant, arising from the capacitance Cₚₙ of the region 323 and the series resistance corresponding to the resistors Rₚ and Rₙ. In some examples, the modulation efficiency of the ridge waveguide core 220 may be increased either by doping the sides 222, 224 with higher dopant concentrations (which introduce more carriers) or by introducing more complex doping schemes directed at expanding the depletion region to improve the electro-optic overlap. However, increasing the dopant concentrations typically increases the free carrier absorption, which may increase the insertion loss of the modulator. Although such methods may be effective in enhancing the modulation efficiency, they may typically involve certain trade-offs between efficiency, bandwidth, and insertion loss.

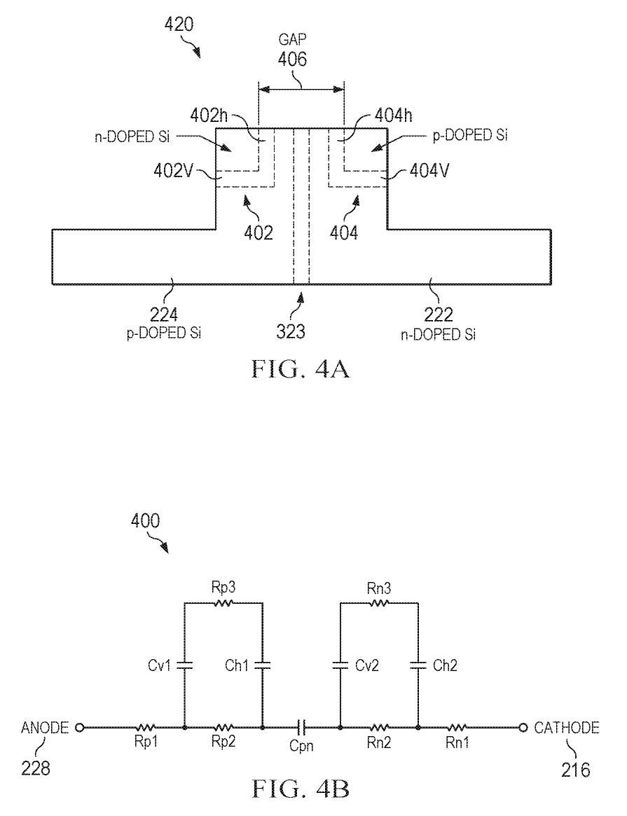

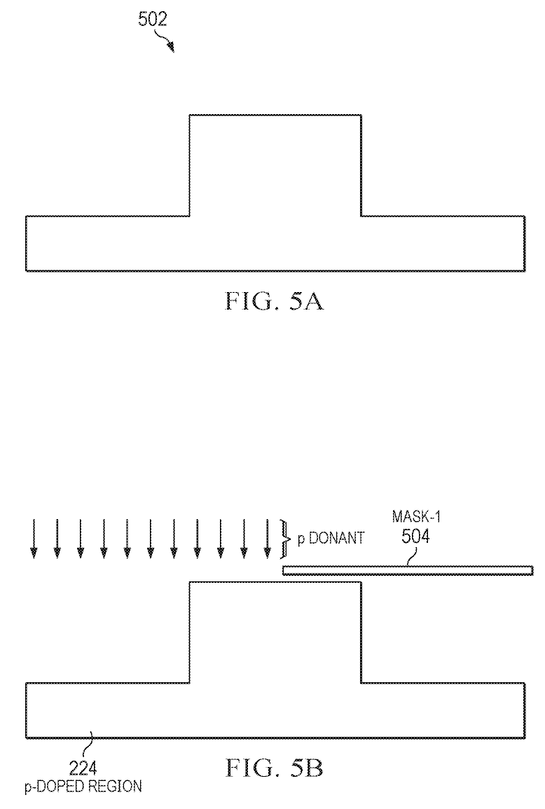

At least some of the above-indicated problems in the state of the art can beneficially be addressed using various embodiments of a multidirectional p-n junction described in more detail below in reference to FIGS. 4A-10C. Such embodiments may help to simultaneously enhance the modulation efficiency, increase the bandwidth, and reduce the optical insertion loss of the corresponding optical modulator. One aspect of some of such embodiments is the use of a four-mask process to fabricate additional horizontal junctions, termed corner junctions, on either side of the region 323.

FIGS. 4A-4B schematically illustrate structural and electrical characteristics of a ridge waveguide core 420 that can be used in the optical phase shifter 200 according to some examples. More specifically, FIG. 4A is a schematic cross-sectional side view of the ridge waveguide core 420. FIG. 4B is a schematic diagram illustrating a small signal equivalent circuit representation (model) 400 of the ridge waveguide core 420 in the optical phase shifter 200 (also see FIG. 2).

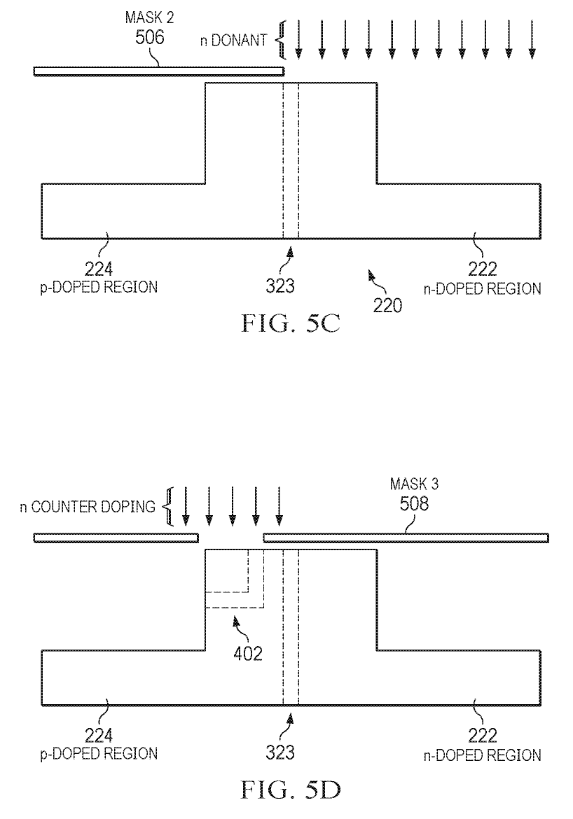

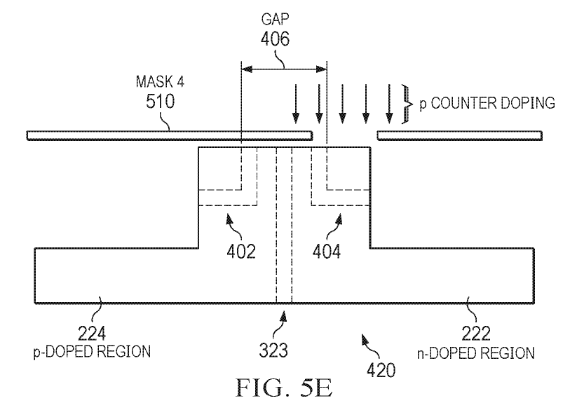

The ridge waveguide core 420 can be viewed as a modification of the ridge waveguide core 220 (also see FIG. 3A). As such, the ridge waveguide core 420 inherits the anode side 224, the cathode side 222, and the p-n junction region 323 from the ridge waveguide core 220 (FIG. 3A). The ridge waveguide core 420 also has two corner junctions 402, 404 formed by low-energy opposite-implant doping (counter doping), which introduces p-type doping in the n-doped side 222 and n-type doping in the p-doped side 224, e.g., as described in more detail below in reference to FIGS. 5A-5E.

The corner junction 402 includes a vertical-junction portion 402v and a horizontal-junction portion 402h. The corner junction 404 similarly includes a vertical-junction portion 404v and a horizontal-junction portion 404h. The presence of the corner junctions 402 and 404 and the middle junction 323 results in a multidirectional junction configuration in the core 420. A gap distance 406 between the horizontal-junction portions 402h and 404h is a design parameter of the ridge waveguide core 420 that can be selected to achieve one or more desired characteristics for the corresponding embodiment of the optical phase shifter 200.

In the circuit model 400 (FIG. 4B), the central capacitor Cₚₙ is analogous to the capacitor Cₚₙ illustrated in FIG. 3B. The circuit model 400 also has: (i) two additional capacitors (labeled Cₕ₁ and Cₕ₂) corresponding to the horizontal-junction portions 402h and 404h, respectively, and (ii) two more capacitors (labeled Cᵥ₁ and Cᵥ₂) corresponding to the vertical-junction portions 402v and 404v, respectively, giving rise to the above-mentioned multidirectional junction configuration. A device with a cross-section illustrated in FIG. 4A and represented by the circuit model 400 may beneficially have a larger RC bandwidth than the device illustrated in FIGS. 3A-3B, thereby simultaneously achieving a better modulation efficiency, a lower optical insertion loss, and a larger RC bandwidth, without inherent reliance on the above-mentioned trade-offs typically applied during optimization of the single-junction design.

Herein, the terms “vertical” and “horizontal” refer to the two mutually orthogonal directions defined with respect to the SOI wafer or its substrate 202 illustrated in FIG. 2. More specifically, the vertical direction is a direction orthogonal to a main plane of the SOI wafer or substrate 202, whereas the horizontal direction is a direction parallel to the main plane of the SOI wafer or substrate 202. Herein, a “main plane” of an object, such as a die, a PIC, a substrate, a wafer, or an IC, is a plane parallel to a substantially planar surface thereof that has the largest sizes, e.g., length and width, among all exterior surfaces of the object. This substantially planar surface is referred to as a main surface. The exterior surfaces of the object that have one relatively large size, e.g., length, and one relatively small size, e.g., height, are typically referred to as the edges of the object.

In the circuit model 400, the various above-mentioned disjoint capacitors are arranged in a series-parallel configuration, which effectively reduces the overall capacitance of the system. For example, a shown combination of capacitors in series tends to bring down the effective capacitance of the circuit, which is beneficial for improving the RC bandwidth of the corresponding modulator 120. The capacitors Cᵥ₁, Cₕ₁, Cᵥ₂, and Cₕ₂ are created by the corner junctions 402, 404 under reverse electrical bias. Electrical simulations show that the low-energy implants used to create the corner junctions 402, 404 do not significantly increase the resistance when designed properly. This characteristic of the ridge waveguide core 420 ensures that the modulator maintains low resistance, preserving its high-speed performance while benefiting from the enhanced modulation efficiency and reduced capacitance provided by the multidirectional junction structure. Thus, the structure and electrical characteristics of the ridge waveguide core 420 can beneficially be leveraged to overcome certain limitations of conventional designs, e.g., by optimizing the depletion region’s structure and minimizing the overall capacitance without compromising resistance, thereby delivering an efficient and well-performing optical modulator.

FIGS. 5A-5E schematically illustrate a method of fabricating the ridge waveguide core 420 according to some examples.

FIG. 5A is a schematic cross-sectional side view of a ridge waveguide core 502 that serves as a foundational structure for the nascent ridge waveguide core 420. In some examples, the ridge waveguide core 502 can be formed by patterning and etching the device layer 206 of the corresponding SOI wafer (also see FIG. 2).

FIGS. 5B-5C schematically illustrate the fabrication steps involved in converting the ridge waveguide core 502 into the ridge waveguide core 220 (also see FIGS. 2, 3A). These steps include selective ion implantation into the ridge waveguide core 502 using lithographic masks 504 and 506 to define the p-type region 224 and the n-type region 222, respectively, in the ridge waveguide core 502. In some examples, to ensure a uniform doping concentration across the vertical profile of the waveguide core 502, the implantation may be executed in multiple stages with different implant energies for a single doping type using the same mask. The p-n junction region 323 is formed at the conclusion of the fabrication steps corresponding to FIGS. 5B-5C.

FIGS. 5D-5E schematically illustrate the fabrication steps involved in converting the ridge waveguide core 220 into the ridge waveguide core 420 (also see FIG. 4A). These steps include counter-doping processes directed at forming secondary depletion layers that act as capacitive elements in a series arrangement with the primary p-n junction 323. By placing these capacitive elements in series, the total equivalent capacitance of the resulting modulator system is reduced, thereby directly increasing the RC-limited bandwidth. The formation of the corner junctions 402, 404 is implemented using lithographic masks 508 and 510 as indicated in FIGS. 5D and 5E, respectively. More specifically, the mask 508 is used to selectively introduce n-type dopants into the p-doped side 224. The mask 510 is similarly used to introduce p-type dopants into the n-doped side 222.

Variations in the dosage and energy of the counter-implants allow for the creation of distinct structural embodiments tailored to specific performance requirements. For example, in one embodiment, the counter-doping is configured to neutralize portions of the primary doping to create intrinsic-like regions, which tends to minimize the optical loss therein. In another embodiment, utilizing a lower energy implant at a lower dosage may result in reduced free-carrier absorption losses at the expense of a slight increase of the series resistance. In yet another embodiment, the local implant dose of the counter doping exceeds the doping concentration present due to the primary doping.

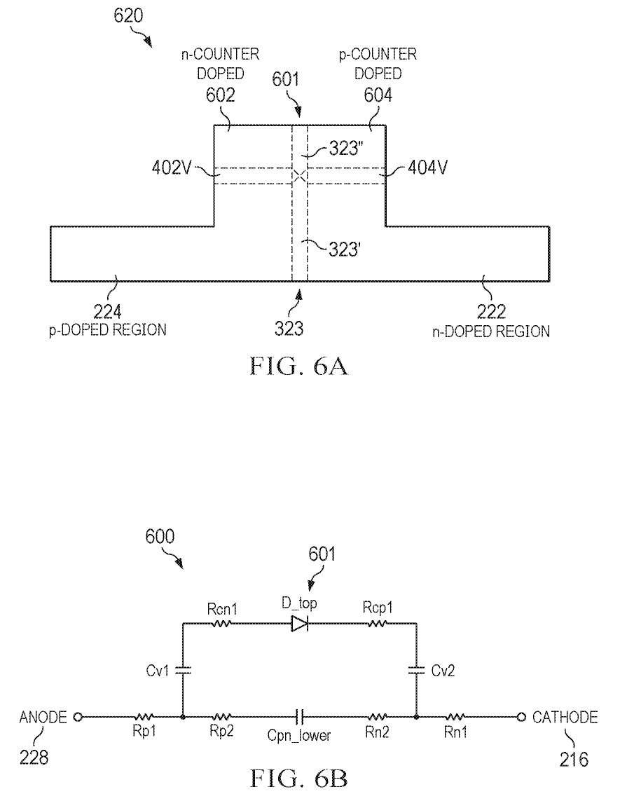

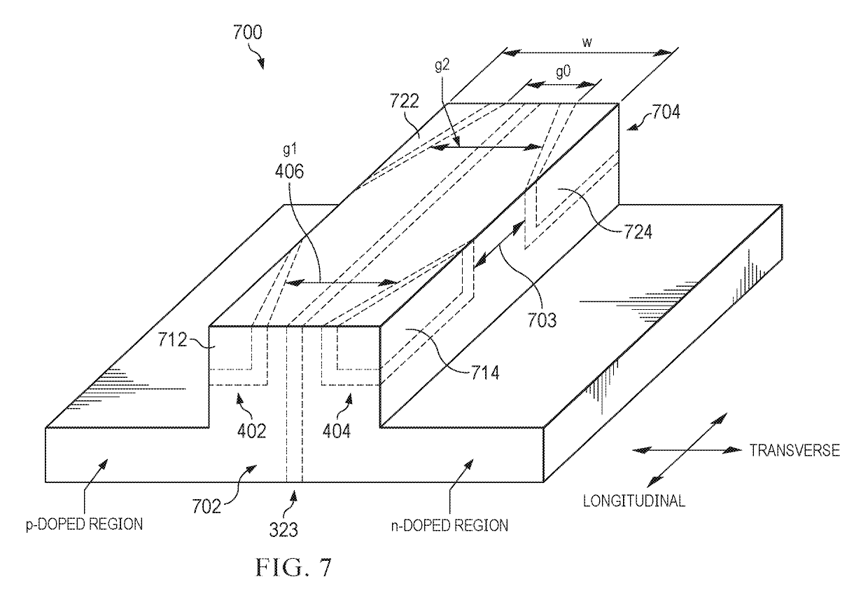

FIGS. 6A-6B schematically illustrate structural and electrical characteristics of a ridge waveguide core 620 that can be used in the optical phase shifter 200 according to some examples. More specifically, FIG. 6A is a schematic cross-sectional side view of the ridge waveguide core 620. FIG. 6B is a schematic diagram illustrating a small signal equivalent circuit representation (model) 600 of the ridge waveguide core 620 in the optical phase shifter 200 (also see FIG. 2).

The ridge waveguide core 620 can be viewed as an embodiment of the ridge waveguide core 420 in which the gap distance 406 is set to zero (also see FIG. 4A). This particular embodiment may be referred to as the T-junction embodiment. The corresponding T-junction includes the edge-connected junctions 402v and 404v and the lower portion of the junction 323 (which is labeled 323´ in FIG. 6A). On top of the T-junction 402v/404v/323´ sits a diode 601 formed by directly connected n-counter-doped region 602 and p-counter-doped region 604, with the connection having been made due to the above-mentioned zero gap distance 406. Note that the orientation of the diode 601 is the opposite to that of the diode 210 (also see FIG. 2).

In the model 600, the two vertical junctions 402v and 404v on either side of the central p-n junction 323´ of the T-junction are represented by capacitors Cᵥ₁ and Cᵥ₂, respectively. The central depletion region 323 is divided into two parts, with a top portion 323´´ being modeled as a forward biased diode 601 (D_top) and the bottom portion 323´ being modeled as a reverse biased diode represented by a capacitor Cpn_lower. In at least some use cases, the T-junction design of the ridge waveguide core can further improve the modulation efficiency and reduce the optical insertion losses of the corresponding optical modulator.

In some examples, the counter-doping steps (e.g., see FIGS. 5D-5E) used in the fabrication of the waveguide cores 420, 620 may increase the defect density which in turn may increase the probability of photogenerated carriers in relatively close proximity to the additional depletion zones. Unlike for the carriers in the conventional lateral p-n junction design, there is no readily available paths for electrons to escape when the p-doped regions have been counter-doped with n-dopants and also for holes to escape when the n-doped regions have been counter-doped with p-dopants. The presence of those additional carriers may screen the electric field, which may reduce desirable manifestations of the DC Kerr effect and/or increase optical loss. In addition, the probability that the carriers traverse the depletion regions is dictated by the transit time of the electrons and holes. Signal frequencies that are below and above the inverse of this transit time will have different modulation efficiencies which is not a desirable characteristic where the intent is for all frequencies to behave similarly.

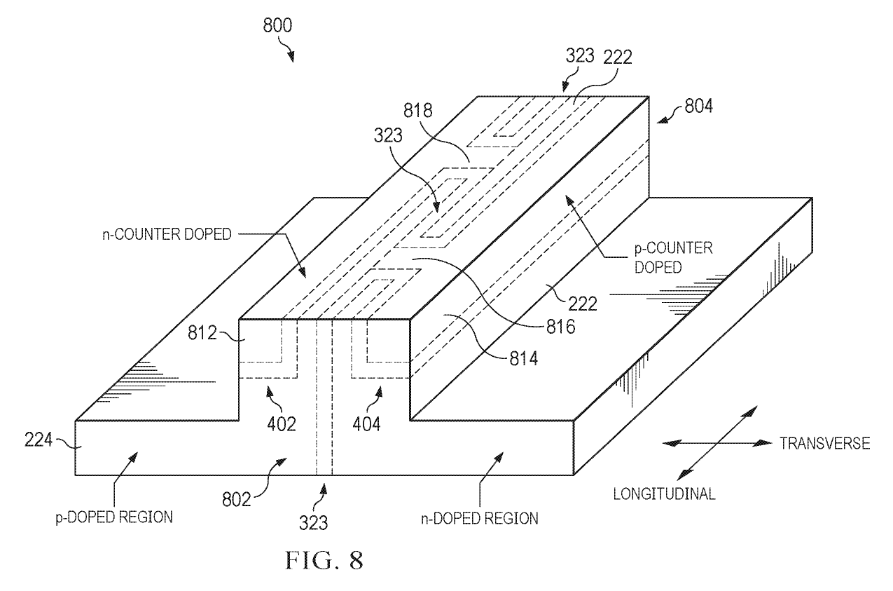

To mitigate the above-indicated effects, the counter-doped regions can be periodically or occasionaly eliminated in the longitudal direction through tapering, interleaving, or other suitable means, thereby providing reoccurring carrier drainage pathways that can prevent the accumulation of free charge which would otherwise screen the modulation field. Example longitudinal profiles implementing this approach are described in more detail below in reference to FIGS. 7-8.

FIG. 7 is a schematic diagram illustrating a 3D perspective view of a longitudinal section 700 of the ridge waveguide core 420 according to some examples. The structure of the section 700 can be best understood based on transverse cross-sections thereof taken at different positions along the longitudinal direction. For example, a transverse cross-section taken at the front end 702 of the section 700 is substantially the same as the cross-section shown in and described in reference to FIG. 4A. As one begins to move along the longitudinal direction toward a back end 704 of the section 700, the width g ₁ of the gap 406 gradually increases until it reaches the full width W of the waveguide’s ridge. At that point, counter-doped regions 712 and 714 have completely tapered off and are absent in any transverse cross-section taken within a sub-section 703 of the section 700. Each of such transverse cross-sections is substantially the same as the cross-section shown in and described in reference to FIG. 3A. After one reaches the distal end of the sub-section 703, the counter-doped regions reappear in the transverse cross-sections due to the presence of counter-doped regions 722 and 724. In the example shown, the counter-doped regions 722 and 724 are analogous to the counter-doped regions 712 and 714, respectively, but have the opposite taper direction. In other words, as one continues to move in the longitudinal direction toward the back end 704 of the section 700, the width g ₂ of the gap 406 gradually decreases until it reaches its minimum value g ₀ at the back end 704. A transverse cross-section taken at the back end 704 of the section 700 is substantially the same as the cross-section shown in and described in reference to FIG. 4A.

In some examples, a plurality of sections 700 can be used as building blocks for constructing a longer waveguide section. For example, multiple sections 700 may be serially end-connected to one another to build a longitudinally varying and/or periodic counter-doping profile for an optical waveguide used in the optical modulator 120.

FIG. 8 is a schematic diagram illustrating a 3D perspective view of a longitudinal section 800 of the ridge waveguide core 420 according to some additional examples. A transverse cross-section taken at a front end 802 of the section 800 is substantially the same as the cross-section shown in and described in reference to FIG. 4A. Similarly, a transverse cross-section taken at a back end 804 of the section 800 is substantially the same as the cross-section shown in and described in reference to FIG. 4A. Counter-doped regions 812 and 814 are generally uniform along the longitudinal direction of the section 800 except for the bridge areas 814 and 816, wherein the counter-doped regions 812 and 814 have lateral extensions toward the center of the ridge waveguide core. More specifically, the p-counter doped region 814 has a lateral extension in the bridge area 816 connecting to the p-doped side 224 of the ridge waveguide core 420. Similarly, the n-counter doped region 812 has a lateral extension in the bridge area 818 connecting to the n-doped side 222 of the ridge waveguide core 420. As such, the bridge areas 816 and 818 provide respective resistively conducting paths configured to effectively remove photogenerated carriers away from the counter doped regions.

In some examples, a plurality of sections 800 can be used as building blocks for constructing a longer waveguide section. For example, multiple sections 800 may be serially end-connected to one another to build a longitudinally varying and/or periodic counter-doping profile for an optical waveguide used in the optical modulator 120.

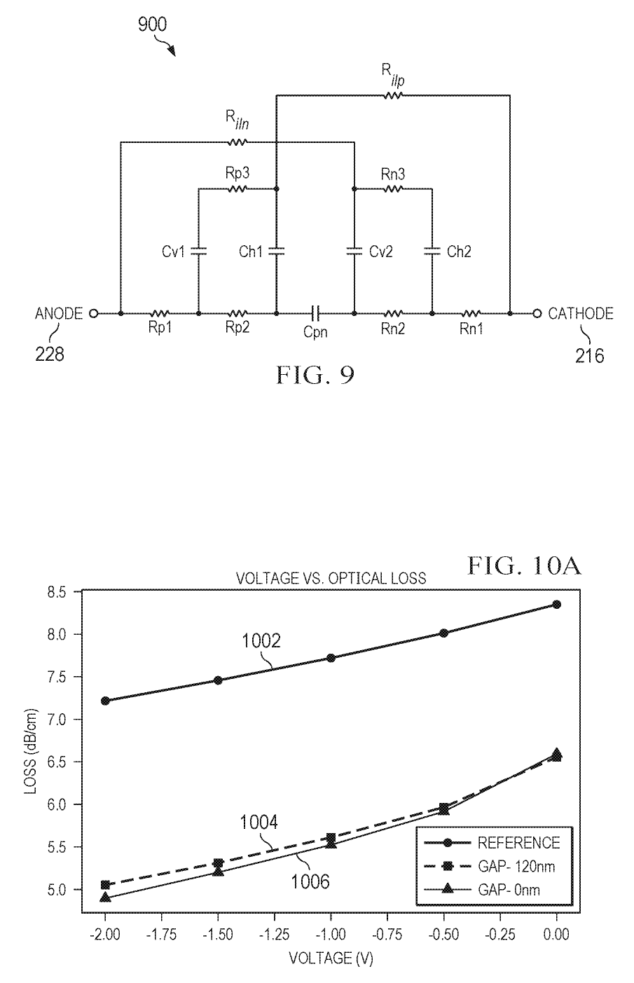

FIG. 9 is a schematic diagram illustrating a small signal equivalent circuit representation (model) 900 of the section 800 in the optical phase shifter 200 (also see FIG. 2) according to some examples. The model 900 is generally similar to the model 400 of FIG. 4B but includes two additional resistive paths corresponding to the lateral extensions of the counter-doped regions 812 and 814 in the bridge areas 818 and 816, respectively. More specifically, the lateral extension of the counter-doped region 812 in the bridge area 818 is represented in the model 900 by a resistor Rᵢₗₙ. The lateral extension of the counter-doped region 818 in the bridge area 816 is represented in the model 900 by a resistor Rᵢₗₚ.

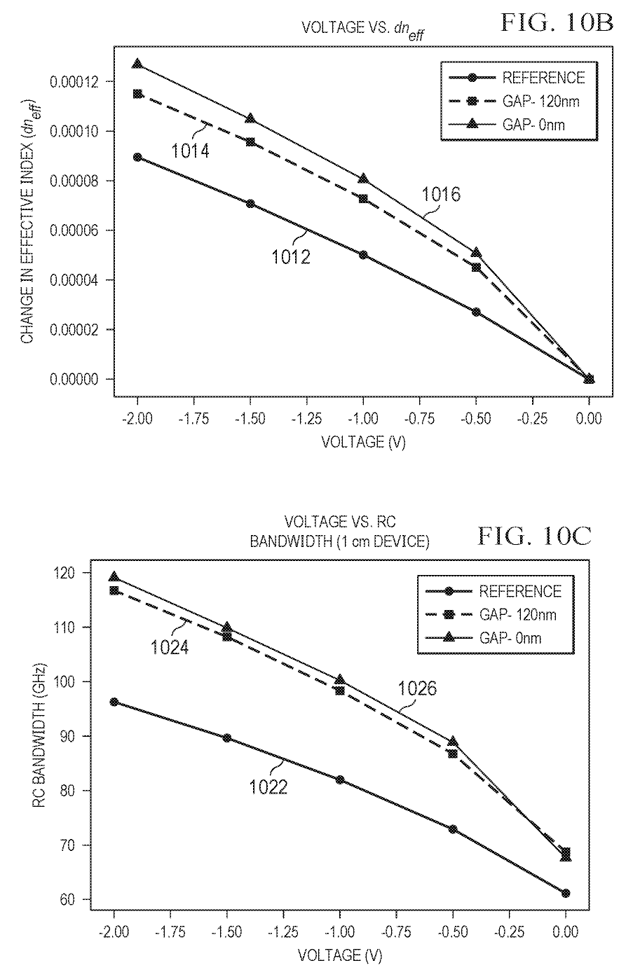

FIGS. 10A-10C graphically compare selected performance characteristics of several ridge waveguide cores in the optical modulator 120 according to some examples. More specifically, the performance characteristics of the waveguide core 220 are used as a reference and are represented by curves 1002, 1012, and 1022. The performance characteristics of the waveguide core 420 having the gap distance 406 of 120 nm are represented by curves 1004, 1014, and 1024. The performance characteristics of the waveguide core 620 are represented by curves 1006, 1016, and 1026.

FIG. 10A graphically illustrates the relationship between the applied reverse bias and optical propagation loss. The shown data indicate that the designs represented by the ridge waveguide cores 420 and 620 can significantly lower the optical insertion loss. While the reference design exhibits relatively high loss due to extensive carrier interactions, the designs represented by the ridge waveguide cores 420 and 620 successfully create extra depletion regions to reduce free-carrier absorption. In this particular aspect, the design represented by the ridge waveguide core 620 maintains the lowest overall loss profile, ensuring that more light reaches the output with less signal degradation.

FIG. 10B graphically illustrates the modulation efficiency based on the change in the effective refractive index (dn_{eff}) across a voltage swing. The shown data demonstrate that the designs represented by the ridge waveguide cores 420 and 620 can achieve a higher level of electro-optic overlap, due to the additional depletion regions. This increased efficiency allows the corresponding embodiment of modulator 120 to achieve the target phase shift with lesser electrical energy and/or with a more compact device footprint compared to the reference design.

FIG. 10C graphically compares high-speed performance of the selected designs. The shown data indicate a significant performance benefit demonstrated by the designs represented by the ridge waveguide cores 420 and 620. For example, for a reference device length of 1 cm, the designs represented by the ridge waveguide cores 420 and 620 offer higher RC bandwidths than the reference design. This improvement is primarily due to the reduction in the effective junction capacitance provided by the designs represented by the ridge waveguide cores 420 and 620.

In the following description, numerous details are set forth, such as optical device configurations, timings, operations, and the like, in order to provide an understanding of one or more aspects of the present disclosure. It will be readily apparent to one skilled in the art that these specific details are mere examples and are not intended to limit the scope of this application.

According to an example embodiment disclosed above, e.g., in the summary section and/or in reference to any one or any combination of some or all of FIGS. 1-10, provided is an apparatus comprising: a substrate; and a ridge waveguide core disposed along the substrate and comprising a semiconductor material that includes: a first n-doped region and a first p-doped region arranged to form a first p-n junction along a longitudinal direction of the ridge waveguide core; a second n-doped region formed by counter-doping a portion of the first p-doped region; and a second p-doped region formed by counter-doping a portion of the first n-doped region, wherein the second n-doped region and the first p-doped region are arranged to form a second p-n junction along the longitudinal direction; and wherein the second p-doped region and the first n-doped region are arranged to form a third p-n junction along the longitudinal direction.

In some embodiments of the above apparatus, the semiconductor material comprises silicon.

In some embodiments of any of the above apparatus, the first, second, and third p-n junctions are edge-connected to form a T-shaped p-n junction in a transverse cross-section of the ridge waveguide core.

In some embodiments of any of the above apparatus, under a reverse bias applied to the first p-n junction, the second and third p-n junctions are configured as respective effective capacitors serially connected with one another and further connected in parallel with an effective capacitor of the first p-n junction.

In some embodiments of any of the above apparatus, the second n-doped region and the second p-doped region are arranged to form a fourth p-n junction along the longitudinal direction; and wherein the first p-n junction and the fourth p-n junction have opposite orientations in the transverse cross-section.

In some embodiments of any of the above apparatus, the second n-doped region and the second p-doped region have a non-zero separation distance along a transverse direction of the ridge waveguide core.

In some embodiments of any of the above apparatus, the non-zero separation distance changes along the longitudinal direction.

In some embodiments of any of the above apparatus, a portion of the first p-n junction is located between the second n-doped region and the second p-doped region.

In some embodiments of any of the above apparatus, the second p-n junction has a first portion thereof oriented substantially parallel (e.g., within ±5 or 10 degrees of strict parallelism) to a main surface of the substrate and a second portion thereof oriented substantially orthogonal (e.g., within ±5 or 10 degrees of strict orthogonality) to the main surface; and wherein the third p-n junction includes a first portion thereof oriented substantially parallel to the main surface and a second portion thereof oriented substantially orthogonal to the main surface.

In some embodiments of any of the above apparatus, under a reverse bias applied to the first p-n junction: the first and second portions of the second p-n junction are configured as respective first effective capacitors serially connected with one another and further serially connected with an effective capacitor of the first p-n junction; and the first and second portions of the third p-n junction are configured as respective second effective capacitors serially connected with one another and further serially connected with the effective capacitor of the first p-n junction.

In some embodiments of any of the above apparatus, within a first longitudinal section of the ridge waveguide core, the first n-doped region is in direct contact with the second n-doped region; and wherein, within a different second longitudinal section of the ridge waveguide core, the first p-doped region is in direct contact with the second p-doped region.

In some embodiments of any of the above apparatus, the apparatus further comprises a dielectric layer supported on the substrate and adjacent to the ridge waveguide core, wherein the dielectric layer is configured to provide a cladding to the ridge waveguide core.

In some embodiments of any of the above apparatus, the apparatus further comprises: a laser optically coupled to the ridge waveguide core and configured to transmit light therethrough; and electrical driver configured to modulate a voltage across the first p-n junction in response to a data stream to cause the ridge waveguide core to modulate the transmitted light.

According to another example embodiment disclosed above, e.g., in the summary section and/or in reference to any one or any combination of some or all of FIGS. 1-10, provided is a fabrication method, comprising: forming a ridge waveguide core on a substrate, the ridge waveguide core comprising a semiconductor material; n-doping the semiconductor material to create a first n-doped region in the ridge waveguide core; p-doping the semiconductor material to create a first p-doped region in the ridge waveguide core; counter-doping a portion of the first p-doped region to create a second n-doped region in the ridge waveguide core; counter-doping a portion of the first n-doped region to create a second p-doped region in the ridge waveguide core, wherein the first n-doped region and the first p-doped region arranged to form a first p-n junction along a longitudinal direction of the ridge waveguide core; wherein the second n-doped region and the first p-doped region are arranged to form a second p-n junction along the longitudinal direction; and wherein the second p-doped region and the first n-doped region are arranged to form a third p-n junction along the longitudinal direction.

In some embodiments of the above method, the semiconductor material comprises silicon.

In some embodiments of any of the above methods, the ridge waveguide core is formed in a device layer of a SOI wafer including the substrate.

In some embodiments of any of the above methods, the method further comprises depositing a dielectric layer over the device layer to provide a cladding to the ridge waveguide core.

In some embodiments of any of the above methods, the first, second, and third p-n junctions are edge-connected to form a T-shaped p-n junction in a transverse cross-section of the ridge waveguide core.

In some embodiments of any of the above methods, the second n-doped region and the second p-doped region have a non-zero separation distance along a transverse direction of the ridge waveguide core; and wherein a portion of the first p-n junction is located between the second n-doped region and the second p-doped region.

In some embodiments of any of the above methods, within a first longitudinal section of the ridge waveguide core, the first n-doped region is in direct contact with the second n-doped region; and wherein, within a different second longitudinal section of the ridge waveguide core, the first p-doped region is in direct contact with the second p-doped region.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in fewer than all features of a single disclosed embodiment. Thus, the following claims are hereby incorporated into the Detailed Description, with each claim standing on its own as a separately claimed subject matter.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Some embodiments may be implemented as circuit-based processes, including possible implementation on a single integrated circuit.

Unless explicitly stated otherwise, each numerical value and range should be interpreted as being approximate as if the word “about” or “approximately” preceded the value or range.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used in this application, the terms “circuit,” “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Any numerical range recited herein includes all values from the lower value to the upper value. For example, if a range is stated as 1% to 50%, it is intended that the narrower ranges thereof, such as 2% to 40%, 10% to 30%, 1% to 3%, etc., are expressly enumerated by said statement. These specific examples represent only a limited subset of what is intended to be covered, and all possible combinations of numerical values between and including the lowest value and the highest value of the enumerated range are to be considered to be expressly stated in this application. Concentration ranges, dose ranges, and other ranges of specific parameters are intended to be interpreted in a manner similar to the “%” example.

The modifier “about” or “approximately” used in connection with a quantity is inclusive of the stated value and has the meaning dictated by the context (for example, it includes at least the degree of error associated with the measurement of the particular quantity). The modifier “about” or “approximately” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so that, for example, “about 1” may also mean from 0.5 to 1.4.

“BRIEF SUMMARY OF SOME SPECIFIC EMBODIMENTS” in this specification is intended to introduce some example embodiments, with additional embodiments being described in “DETAILED DESCRIPTION” and/or in reference to one or more drawings. “BRIEF SUMMARY OF SOME SPECIFIC EMBODIMENTS” is not intended to identify essential elements or features of the claimed subject matter, nor is it intended to limit the scope of the claimed subject matter.

What is claimed is:

1. An apparatus, comprising:
a substrate; and
a ridge waveguide core disposed along the substrate and comprising a semiconductor material that includes:
a first n-doped region and a first p-doped region arranged to form a first p-n junction along a longitudinal direction of the ridge waveguide core;
a second n-doped region formed by counter-doping a portion of the first p-doped region; and
a second p-doped region formed by counter-doping a portion of the first n-doped region,
wherein the second n-doped region and the first p-doped region are arranged to form a second p-n junction along the longitudinal direction; and
wherein the second p-doped region and the first n-doped region are arranged to form a third p-n junction along the longitudinal direction.

2. The apparatus of claim 1, wherein the semiconductor material comprises silicon.

3. The apparatus of claim 1, wherein the first, second, and third p-n junctions are edge-connected to form a T-shaped p-n junction in a transverse cross-section of the ridge waveguide core.

4. The apparatus of claim 3, wherein, under a reverse bias applied to the first p-n junction, the second and third p-n junctions are configured as respective effective capacitors serially connected with one another and further connected in parallel with an effective capacitor of the first p-n junction.

5. The apparatus of claim 3,
wherein the second n-doped region and the second p-doped region are arranged to form a fourth p-n junction along the longitudinal direction; and
wherein the first p-n junction and the fourth p-n junction have opposite orientations in the transverse cross-section.

6. The apparatus of claim 1, wherein the second n-doped region and the second p-doped region have a non-zero separation distance along a transverse direction of the ridge waveguide core.

7. The apparatus of claim 6, wherein the non-zero separation distance changes along the longitudinal direction.

8. The apparatus of claim 6, wherein a portion of the first p-n junction is located between the second n-doped region and the second p-doped region.

9. The apparatus of claim 6,
wherein the second p-n junction has a first portion thereof oriented substantially parallel to a main surface of the substrate and a second portion thereof oriented substantially orthogonal to the main surface; and
wherein the third p-n junction includes a first portion thereof oriented substantially parallel to the main surface and a second portion thereof oriented substantially orthogonal to the main surface.

10. The apparatus of claim 9, wherein, under a reverse bias applied to the first p-n junction:
the first and second portions of the second p-n junction are configured as respective first effective capacitors serially connected with one another and further serially connected with an effective capacitor of the first p-n junction; and
the first and second portions of the third p-n junction are configured as respective second effective capacitors serially connected with one another and further serially connected with the effective capacitor of the first p-n junction.

11. The apparatus of claim 6,
wherein, within a first longitudinal section of the ridge waveguide core, the first n-doped region is in direct contact with the second n-doped region; and
wherein, within a different second longitudinal section of the ridge waveguide core, the first p-doped region is in direct contact with the second p-doped region.

12. The apparatus of claim 1, further comprising a dielectric layer supported on the substrate and adjacent to the ridge waveguide core,
wherein the dielectric layer is configured to provide a cladding to the ridge waveguide core.

13. The apparatus of claim 1, further comprising:
a laser optically coupled to the ridge waveguide core and configured to transmit light therethrough; and
electrical driver configured to modulate a voltage across the first p-n junction in response to a data stream to cause the ridge waveguide core to modulate the transmitted light.

14. A fabrication method, comprising:
forming a ridge waveguide core on a substrate, the ridge waveguide core comprising a semiconductor material;
n-doping the semiconductor material to create a first n-doped region in the ridge waveguide core;
p-doping the semiconductor material to create a first p-doped region in the ridge waveguide core;
counter-doping a portion of the first p-doped region to create a second n-doped region in the ridge waveguide core;
counter-doping a portion of the first n-doped region to create a second p-doped region in the ridge waveguide core,
wherein the first n-doped region and the first p-doped region arranged to form a first p-n junction along a longitudinal direction of the ridge waveguide core;
wherein the second n-doped region and the first p-doped region are arranged to form a second p-n junction along the longitudinal direction; and
wherein the second p-doped region and the first n-doped region are arranged to form a third p-n junction along the longitudinal direction.

15. The method of claim 14, wherein the semiconductor material comprises silicon.

16. The method of claim 15, wherein the ridge waveguide core is formed in a device layer of a SOI wafer including the substrate.

17. The method of claim 16, further comprising depositing a dielectric layer over the device layer to provide a cladding to the ridge waveguide core.

18. The method of claim 14, wherein the first, second, and third p-n junctions are edge-connected to form a T-shaped p-n junction in a transverse cross-section of the ridge waveguide core.

19. The method of claim 14,
wherein the second n-doped region and the second p-doped region have a non-zero separation distance along a transverse direction of the ridge waveguide core; and
wherein a portion of the first p-n junction is located between the second n-doped region and the second p-doped region.

20. The method of claim 19,
wherein, within a first longitudinal section of the ridge waveguide core, the first n-doped region is in direct contact with the second n-doped region; and
wherein, within a different second longitudinal section of the ridge waveguide core, the first p-doped region is in direct contact with the second p-doped region.
